(19) United States
(12) Patent Application Publication
(10) Pub. No.: US 2018/0255137 A1
(43) Pub. Date: Sep. 6, 2018

(54) UNIFIED RESOURCE MANAGEMENT IN A DATA CENTER CLOUD ARCHITECTURE

(71) Applicant: Futurewei Technologies, Inc., Plano, TX (US)

(72) Inventors: Luhui Hu, Bellevue, WA (US); Hui Zang, Santa Clara, CA (US); Ziang Hu, Santa Clara, CA (US)

(21) Appl. No.: 15/448,444

(22) Filed: Mar. 2, 2017

(51) Int. Cl. H04L 29/08; H04L 29/06

(52) U.S. Cl. CPC H04L 67/1097; H04L 63/083; H04L 63/101; H04L 67/30

(57) ABSTRACT

A mobile device, computer readable medium, and method are provided for allocating resources within a cloud. The method includes the steps of collecting profile data from a plurality of resource agents and allocating a number of resource units to each resource agent in the plurality of resource agents based on the collected profile data. The allocating may be performed via a resource manager in communication with the plurality of resource agents.

### FIELD OF THE INVENTION

The present disclosure relates to a cloud architecture for management of data center resources, and more particularly to unified resource management solutions implemented within the cloud architecture.

### BACKGROUND

The “cloud” is an abstraction that relates to resource management over a network and, more specifically, to a data center architecture that provides a platform for delivering services via a network. For example, the cloud may refer to various services delivered over the Internet such as network-based storage services or compute services. Typical cloud architecture deployments include a layered hierarchy that includes a physical layer of network hardware, and one or more software layers that enable users to access the network hardware. For example, one common type of cloud architecture deployment includes a physical layer of network resources (e.g., servers, storage device arrays, network switches, etc.) accompanied by a multi-layered hierarchical software framework that includes a first layer that implements Infrastructure as a Service (IaaS), a second layer that implements Platform as a Service (PaaS), and a third layer that implements Software as a Service (SaaS). In general, although there may be exceptions, resources in the third layer are dependent on resources in the second layer, resources in the second layer are dependent on resources in the first layer, and resources in the first layer are dependent on resources in the physical layer.

In conventional cloud architectures, the resources in the physical layer may be allocated to services implemented in the first layer (i.e., IaaS services). For example, a resource manager for the first layer may be configured to allocate resources in the physical layer to different IaaS services running in the first layer. Examples of IaaS services include the Amazon® Elastic Compute Cloud (EC2) platform, which enables a client to reserve one or more nodes in the physical layer of the cloud to perform some computations or run an application, and the Amazon® Simple Storage Service (S3) storage platform, which provides cloud-based storage in one or more data centers. Each instance of an IaaS service may also include a resource manager that requests resources to implement the service from the resource manager of the first layer and manage the allocated resources within the service.

In turn, the resources in the first layer (i.e., IaaS services) may be allocated to services implemented in the second layer (i.e., PaaS services). For example, a resource manager for the second layer may be configured to allocate resources in the first layer to different PaaS services running in the second layer. Examples of PaaS services include the Microsoft® Azure App Service platform, which enables a client to build applications that run on a Microsoft cloud infrastructure, and the Google® Heroku platform, which enables a client to build applications that run on Amazon® IaaS services. PaaS services typically provide containers that manage infrastructure resources such that applications running in the cloud are easily scalable without the developer having to manage those resources. Again, multiple PaaS services may be run simultaneously in the PaaS layer, each PaaS service including a separate and distinct resource manager that is dependent on the resource manager of the PaaS layer for requesting resources to run the PaaS service.

The resources in the second layer (i.e., PaaS services) may be allocated to services implemented in the third layer (i.e., SaaS services). For example, a resource manager for the third layer may be configured to allocate resources from the second layer to different SaaS services running in the third layer. Examples of SaaS services include Salesforce (i.e., customer relations software), Microsoft Office 365, Google Apps, Dropbox, and the like. Each SaaS service in the third layer may request resources from a PaaS service in the second layer in order to run the application. In turn, the PaaS service may request resources from an IaaS service in the first layer to run the platform on which the application depends, and the IaaS service may manage or request a specific subset of resources in the physical layer in one or more data centers of the cloud to be allocated as infrastructure to run the platform.

As the previous description makes clear, each hierarchical layer of the cloud architecture depends on the hierarchical layer below it for allocated resources, although there may be some exceptions where a hierarchical layer calls a hierarchical layer two or more layers below it for allocated resources (e.g., SaaS to IaaS). Resources in the cloud are partitioned vertically on a first-come, first-served basis where each resource manager only allocates the resources allocated to that resource manager to dependent services corresponding to that resource manager. In addition, the resource pools of the cloud may be partitioned horizontally into different clusters, such as by partitioning the total resources in the physical layer of the cloud into individual clusters partitioned by data center or availability zone. As such, each service implemented in a particular cluster only has access to the resources allocated to that cluster, which may be a subset of the resources included in the cloud. The first-come, first-served bases of vertical resource allocation may include two optimizations: high availability and resource locality. High availability requires resources allocated for a service to be evenly distributed, and resource locality requires allocated resources to be close to a source utilizing those resources (e.g., allocate resources close to a client requesting said resources).

The resulting allocation of resources in such architectures is typically inefficient. For example, a particular application (i.e., SaaS) in one cluster may have a high resource utilization rate as many users are using the particular application, which is slowed down because the application can only run on the resources allocated to that cluster, but another application in another cluster may have a low resource utilization rate because only a few users are using the particular application. The resource manager in the first level that allocates resources in the physical layer to the two different clusters may not have visibility into the resource utilization rates of different applications running on each cluster and, therefore, the resources of the physical layer may be utilized inefficiently.

In addition, each service may be designed for a specific platform or cloud based infrastructure. For example, a resource manager for one SaaS service may be designed to utilize the Google® Heroku platform, while a resource manager for another SaaS service may be designed for the Microsoft® Azure App Service platform. Migrating the service from one platform to another platform may take a large amount of effort as programmers develop a compatible resource manager to enable the service to be run on the different platform. Furthermore, some cloud architectures may have different layers, such as a CaaS/SaaS cloud architecture or even a serverless architecture (e.g., Amazon® AWS Lambda).

In general, it is difficult to migrate services built for a particular cloud architecture to another cloud architecture because a service designed for one architecture may depend on receiving allocated resources from other services, which may not be available in other architectures. Furthermore, resource management is typically limited to requesting resources to be allocated to the service from a “parent” resource manager that has access to a particular resource pool. This type of resource management can result in inefficient allocation of the resources available in the cloud.

### SUMMARY

A mobile device, computer readable medium, and method are provided for allocating resources within a cloud. The method includes the steps of collecting profile data from a plurality of resource agents and allocating a number of resource units to each resource agent in the plurality of resource agents based on the collected profile data. The allocating may be performed via a resource manager in communication with the plurality of resource agents.

In a first embodiment, each resource agent in the plurality of resource agents is configured to manage the execution of tasks using the number of resource units allocated to the resource agent.

In a second embodiment (which may or may not be combined with the first embodiment), the cloud comprises a plurality of nodes in one or more data centers. Each node in the plurality of nodes is in communication with at least one other node in the plurality of nodes through one or more networks.

In a third embodiment (which may or may not be combined with the first and/or second embodiments), the cloud further comprises a plurality of storage devices. Each storage device in the plurality of storage devices is coupled to a node in the plurality of nodes

In a fourth embodiment (which may or may not be combined with the first, second, and/or third embodiments), the resource manager includes at least two instances of the resource manager distributed across at least two nodes in the cloud.

In a fifth embodiment (which may or may not be combined with the first, second, third, and/or fourth embodiments), at least one resource agent in the plurality of resource agents is a resource agent fleet.

In a sixth embodiment (which may or may not be combined with the first, second, third, fourth, and/or fifth embodiments), the profile data for a particular resource agent includes a resource type identifier, resource utilization information, and a task execution plan.

In a seventh embodiment (which may or may not be combined with the first, second, third, fourth, fifth, and/or sixth embodiments), the resource manager is configured to generate a resource allocation plan that is stored in a distributed file system in the cloud. Each resource agent in the plurality of resource agents is configured to access at least one instance of the resource allocation plan in the distributed file system.

In a eighth embodiment (which may or may not be combined with the first, second, third, fourth, fifth, sixth, and/or seventh embodiments), the method includes the steps of establishing a secure channel of communication between a secure resource agent and the resource manager, authenticating, via an access control service, a user associated with the secure resource agent as an authorized tenant, collecting profile data from the secure resource agent via the encrypted channel of communication, and allocating, via the resource manager, a number of resource units to the secure resource agent based on the collected profile data.

In a ninth embodiment (which may or may not be combined with the first, second, third, fourth, fifth, sixth, seventh, and/or eighth embodiments), the secure resource agent is configured to manage the execution of tasks within a virtual private cloud.

To this end, in some optional embodiments, one or more of the foregoing features of the aforementioned apparatus, system, and/or method may afford a centralized resource manager that, in turn, may enable the efficient allocation of resources within a cloud. It should be noted that the aforementioned potential advantages are set forth for illustrative purposes only and should not be construed as limiting in any manner.

### BRIEF DESCRIPTION OF THE DRAWINGS

FIGS. 1A and 1B illustrate the infrastructure for implementing a cloud, in accordance with the prior art;

FIG. 2 is a conceptual illustration of a cloud architecture, in accordance with the prior art;

FIG. 3 is a conceptual illustration of a cloud architecture, in accordance with one embodiment;

FIGS. 4A through 4C illustrate a technique for allocating resources in the cloud by the resource manager, in accordance with one embodiment;

FIG. 5 is a flowchart of a method for managing the allocation of resources in a cloud, in accordance with one embodiment;

FIG. 6 is a flowchart of a method for managing the allocation of resources in a cloud, in accordance with one embodiment;

FIG. 7 is a flowchart of a method for managing the execution of tasks by a service, in accordance with one embodiment;

FIG. 8 is a conceptual illustration of a cloud architecture, in accordance with one embodiment;

FIG. 9 illustrates the communications between a secure resource agent, in accordance with one embodiment;

FIG. 10 is a flowchart of a method for managing the allocation of resources in a cloud, in accordance with one embodiment;

FIG. 11 is a flowchart of a method for authenticating an authorized tenant associated with a virtual private cloud, in accordance with one embodiment; and

FIG. 12 illustrates an exemplary system in which the various architecture and/or functionality of the various previous embodiments may be implemented.

### DETAILED DESCRIPTION

Conventionally, resource allocation in a cloud architecture has been implemented based on a resource dependence scheme, where each resource manager in the cloud requests resources from a parent resource manager. In the conventional cloud architecture, many hundreds or thousands of resource managers may be implemented as hundreds or thousands of services are deployed within the cloud. This large network of dependent resource managers are not designed to communicate and, therefore, the allocation of resources among this multi-layered network of resource managers is not likely to be efficient.

One possible solution to the resource allocation problem is to transition from a distributed, multi-layered resource dependence scheme to a physically distributed, logically centralized resource allocation scheme. In this scheme, each resource manager deployed in the cloud is an agent that is dependent on a unified resource manager. The unified resource manager is tasked with allocating resource units among the plurality of resource agents, enabling the unified resource manager to efficiently distribute resource units among all of the services deployed within the cloud.

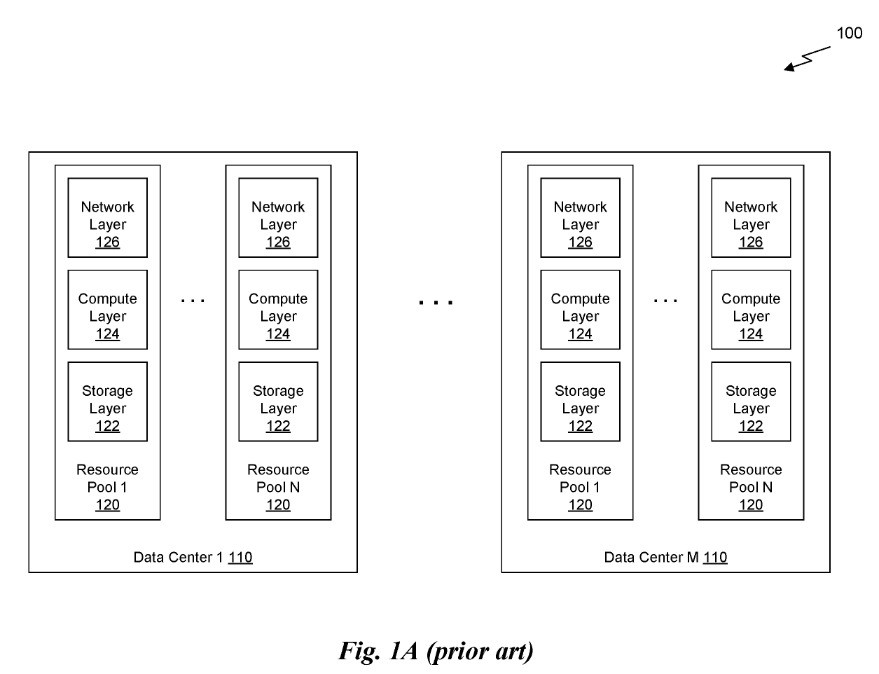

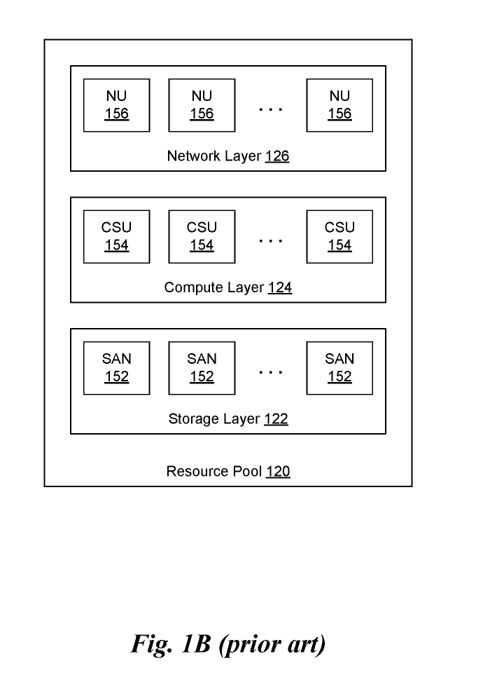

FIGS. 1A and 1B illustrate the infrastructure for implementing a cloud 100, in accordance with the prior art. The cloud 100, as used herein, refers to the set of hardware resources (compute, storage, and networking) located in one or more data centers (i.e., physical locations) and the software framework to implement a set of services across a network, such as the Internet. As shown in FIG. 1A, the cloud 100 includes a plurality of data centers 110, each data center 110 in the plurality of data centers 110 including one or more resource pools 120. A resource pool 120 includes a storage layer 122, a compute layer 124, and a network layer 126.

As shown in FIG. 1B, the storage layer 122 includes the physical resources to store instructions and/or data in the cloud 100. The storage layer 122 includes a plurality of storage area networks (SAN) 152, each SAN 152 provides access to one or more block level storage devices. In one embodiment, a SAN 152 includes one or more non-volatile storage devices accessible via the network. Examples of non-volatile storage devices include, but are not limited to, hard disk drives (HDD), solid state drives (SSD), flash memory such as an EEPROM or Compact Flash (CF) Card, and the like. In another embodiment, a SAN 152 is a RAID (Redundant Array of Independent Disks) storage array that combines multiple, physical disk drive components (e.g., a number of similar HDDs) into a single logical storage unit. In yet another embodiment, a SAN 152 is a virtual storage resource that provides a level of abstraction to the physical storage resources such that a virtual block address may be used to reference data stored in one or more corresponding blocks of memory on one or more physical non-volatile storage devices. In such an embodiment, the storage layer 122 may include a software framework, executed on one or more processors, for implementing the virtual storage resources.

The compute layer 124 includes the physical resources to execute processes (i.e., sets of instructions) in the cloud 100. The compute layer 124 may include a plurality of compute scale units (CSU) 154, each CSU 154 including at least one processor and a software framework for utilizing the at least one processor. In one embodiment, a CSU 154 includes one or more servers (e.g., blade servers) that provide physical hardware to execute sets of instructions. Each server may include one or more processors (e.g., CPU(s), GPU(s), ASIC(s), FPGA(s), DSP(s), etc.) as well as volatile memory for storing instructions and/or data to be processed by the one or more processors. The CSU 154 may also include an operating system, loaded into the volatile memory and executed by the one or more processors, that provides a runtime environment for various processes to be executed on the hardware resources of the server. In another embodiment, a CSU 154 is a virtual machine that provides a collection of virtual resources that emulate the hardware resources of a server. The compute layer 124 may include a hypervisor or virtual machine monitor that enables a number of virtual machines to be executed substantially concurrently on a single server.

The networking layer 126 includes the physical resources to implement networks. In one embodiment, the networking layer 126 includes a number of switches and/or routers that enable data to be communicated between the different resources in the cloud 100. For example, each server in the compute layer 124 may include a network interface controller (NIC) coupled to a network interface (e.g., Ethernet). The interface may be coupled to a network switch that enables data to be sent from that server to another server connected to the network switch. The networking layer 126 may implement a number of layers of the OSI model, including the Data Link layer (i.e., layer 2), the Networking layer (i.e., layer 3), and the Transport layer (i.e., layer 4). In one embodiment, the networking layer 126 implements a virtualization layer that enables virtual networks to be established within the physical network. In such embodiments, each network unit (NU) 156 in the network layer 126 is a virtual private network (VPN).

It will be appreciated that each data center 110 in the plurality of data centers may include a different set of hardware resources and, therefore, a different number of resource pools 120. Furthermore, some resource pools 120 may exclude one or more of the storage layer 122, compute layer 124, and/or network layer 126. For example, one resource pool 120 may include only a set of servers within the compute layer 124. Another resource pool 120 may include both a compute layer 124 and network layer 126, but no storage layer 122.

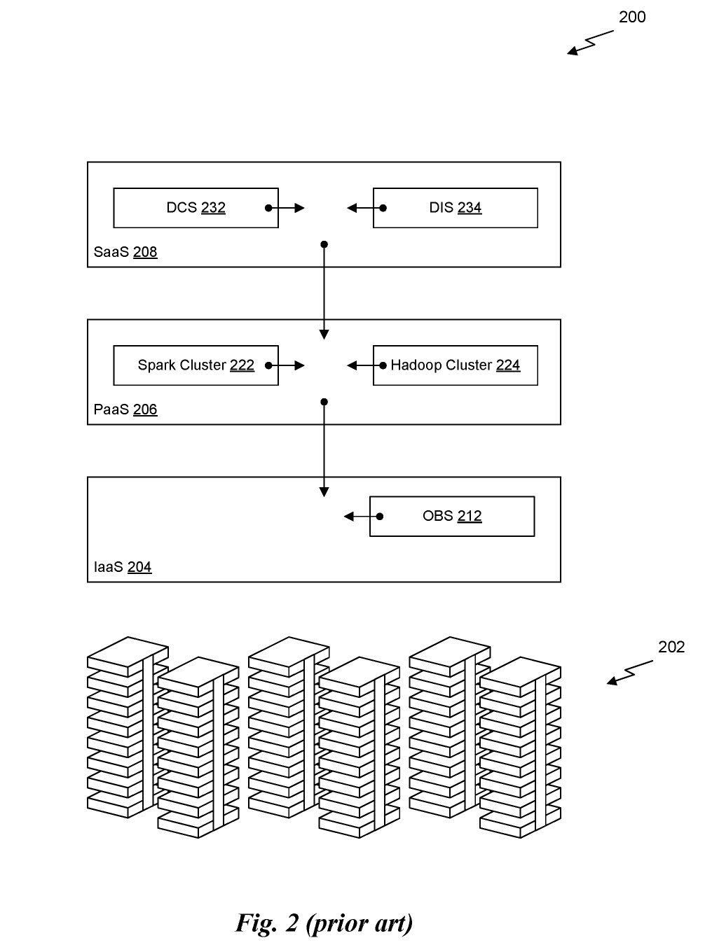

FIG. 2 is a conceptual illustration of a cloud architecture 200, in accordance with the prior art. As shown in FIG. 2, the cloud architecture 200 is represented as a plurality of hierarchical layers. The cloud architecture 200 includes a physical layer 202, an Infrastructure as a Service (IaaS) layer 204, a Platform as a Service (PaaS) layer 206, and a Software as a Service (SaaS) layer 208. The physical layer 202 is the collection of hardware resources that implement the cloud. In one embodiment, the physical layer 202 is implemented as shown in FIGS. 1A and 1B.

The IaaS layer 204 is a software framework that enables the resources of the physical layer 202 to be allocated to different infrastructure services. In one embodiment, the IaaS layer 204 includes a resource manager for allocating resource units (e.g., SAN 152, CSU 154, and NU 156) in the resource pools 120 of the physical layer 202 to services implemented within the IaaS layer 204. As shown in FIG. 2, services such as an Object Storage Service (OBS) 212 may be implemented in the IaaS layer 204. The OBS 212 is a cloud storage service for unstructured or structured data that enables a client to store data in the storage layer 122 of one or more resource pools 120 in the physical layer 202. The OBS 212 may manage where data is stored (i.e., in what data center(s), on which physical drives, etc.) and how data is stored (i.e., n-way replicated data, etc.).

Each service in the IaaS layer 204 may include a separate resource manager that manages the resources allocated to the service. As shown in FIG. 2, black dots within a particular service denote a resource manager for that service and arrows represent a request for resources made by the resource manager of the service to a parent resource manager. In the case of the OBS 212, a resource manager within the OBS 212 requests resources from the resource manager of the IaaS layer 204. Again, the resource manager of the IaaS layer 204 manages the resources from the physical layer 202.

The OBS 212 is only one example of a service implemented within the IaaS layer 204, and the IaaS layer 204 may include other services in addition to or in lieu of the OBS 212. Furthermore, the IaaS layer 204 may include multiple instance of the same service, such as multiple instances of the OBS 212, each instance having a different client facing interface, such that different services may be provisioned for multiple tenants.

The next layer in the hierarchy is the PaaS layer 206. The PaaS layer 206 provides a framework for implementing one or more platform services. For example, as shown in FIG. 2, the PaaS layer 206 may include instances of a Spark Cluster service 222 and a Hadoop Cluster service 224. The Spark Cluster service 222 implements an instance of the Apache™ Spark® platform, which includes a software library for processing data on a distributed system. The Hadoop Cluster service 224 implements an instance of the Apache™ Hadoop® platform, which also includes a software library for processing data on a distributed system. Again, the Spark Cluster service 222 and the Hadoop Cluster service 224 are merely examples of platform services implemented within the PaaS layer 206, and the PaaS layer 206 may include other services in addition to or in lieu of the Spark Cluster service 222 and the Hadoop Cluster service 224.

The platform services in the PaaS layer 206, such as the Spark Cluster service 222 and the Hadoop Cluster service 224, each include an instance of a resource manager. The Spark Cluster service 222 and the Hadoop Cluster service 224 may both utilize the Apache YARN resource manager. These resource managers may request resources from a parent resource manager of the PaaS layer 206. The resource manager of the PaaS layer 206 manages the resources from the IaaS layer 204 allocated to the PaaS layer 206 by the resource manager in the IaaS layer 204.

The top layer in the hierarchy is the SaaS layer 208. The SaaS layer 208 may provide a framework for implementing one or more software services. For example, as shown in FIG. 2, the SaaS layer 208 may include instances of a Data Craft Service (DCS) service 232 and a Data Ingestion Service (DIS) service 234. The DCS service 232 implements an application for processing data, such as transferring or transforming data. The DIS service 234 implements an application for ingesting data, such as collecting data from a variety of different sources and in a variety of different formats and processing the data to be stored in one or more different formats. Again, the DCS service 232 and the DIS service 234 are merely examples of application services implemented within the SaaS layer 208, and the SaaS layer 208 may include other services in addition to or in lieu of the DCS service 232 and the DIS service 234.

The DCS service 232 and the DIS service 234 each include an instance of a resource manager. These resource managers may request resources from a parent resource manager of the SaaS layer 208. The resource manager of the SaaS layer 208 manages the resources allocated to the SaaS layer 208 by the resource manager of the PaaS layer 206.

It will be appreciated that each resource manager in the cloud architecture 200 is associated with a corresponding parent resource manager from which resource units are requested, which may be referred to herein as resource dependence. There may be exceptions to the arrows depicting resource dependence as shown in FIG. 2 when the resource dependence spans layers, such as if the Spark Cluster service 222 may request resources directly from the resource manager of the IaaS layer 204 rather than from the resource manager of the PaaS layer 206. However, in such resource dependence schemes, no single resource manager has visibility into each and every resource unit deployed in the cloud. Thus, no single resource manager can effectively manage the allocation of resource units between different services based on the utilization of each resource unit in the cloud.

It will be appreciated that the cloud architecture 200 shown in FIG. 2 is only one type of architecture framework implemented in conventional clouds. However, other cloud architectures may implement different frameworks. For example, a cloud architecture may include the IaaS layer 204 and the SaaS layer 208 without any intervening PaaS layer 206. In another example, a cloud architecture may include a Container as a Service (CaaS) layer (i.e., a new way of resource virtualization without IaaS and PaaS) plus an SaaS layer on top of the CaaS layer. In each instance, these cloud architectures employ a resource dependence scheme for requesting resources on which to run the service.

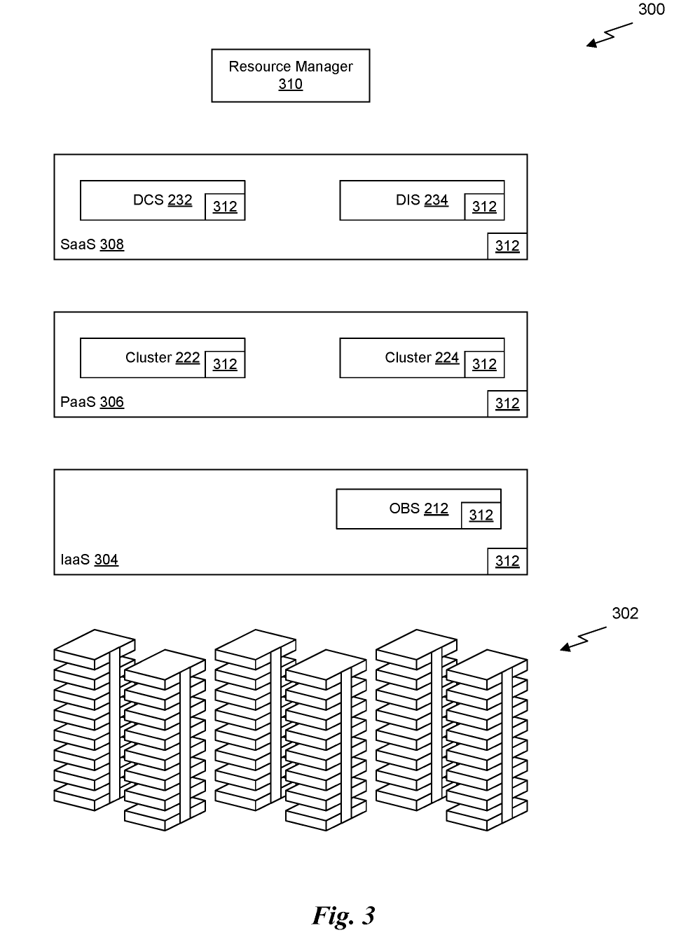

FIG. 3 is a conceptual illustration of a cloud architecture 300, in accordance with one embodiment. As shown in FIG. 3, the cloud architecture 300 is represented as a plurality of hierarchical layers, similar to the cloud architecture 200 shown in FIG. 2. The hierarchical layers may include a physical layer 302, an IaaS layer 304, a PaaS layer 306, and a SaaS layer 308. The IaaS layer 304 may include instances of various infrastructure services, such as the OBS 212; the PaaS layer 306 may include instances of various platform services, such as the Spark Cluster service 222 and the Hadoop Cluster service 224; and the SaaS layer 308 may include instances of various application services, such as the DCS service 232 and the DIS service 234. Again, the types or number of services implemented in each layer may vary according to a particular deployment of services in the cloud.

The cloud architecture 300 shown in FIG. 3 differs from the cloud architecture 200 shown in FIG. 2 in that the scheme utilized for resource allocation is not based on resource dependence. Instead, the cloud architecture 300 shown in FIG. 3 includes a unified resource manager 310 that allocates resource units to each layer or service deployed in the cloud. Each layer in the cloud includes a resource agent 312. In one embodiment, the resource agent 312 is a software module configured to manage the resources allocated to that resource agent 312. The resource agent 312 may request resource units from the resource manager 310 to be allocated to the resource agent 312. The resource manager 310 can allocate resource units independently to each layer of the cloud, and has visibility into the resource requirements of each layer of the cloud based on the requests received from each of the resource agents 302.

Each service may also include a resource agent 312. The resource agent 312 in each service requests resource units from the resource manager 310. Consequently, every resource agent 312 deployed in the cloud is dependent on the unified resource manager 310 such that the resource manager 310 can allocate resource units more efficiently within the cloud.

As used herein, a resource unit may refer to any logical unit of a resource. In the case of the physical layer 302, each resource unit may refer, e.g., to a SAN 152, a CSU 154, or a NU 156. These resource units can be allocated throughout the layers of the cloud. However, each layer and/or service may also define additional resource units that refer to virtual resources implemented by that layer or service. For example, the Spark Cluster service 222 may implement one or more Spark Clusters by grouping, logically, one or more resource units allocated to the Spark Cluster service 222 along with a framework for utilizing those resource units. Consequently, other services, such as services in the SaaS layer 308, may request the allocation of a Spark Cluster rather than the hardware resource units of the physical layer 302. In this case, a resource unit may refer to a Spark Cluster.

In one embodiment, the resource manager 310 may track the resources available in the cloud. The resource manager 310 may discover each of the resource units included in the physical layer 302 such as by polling each node in the cloud to report what resource units are included in the node. Alternatively, the resource manager 310 may read a configuration file, maintained by a network administrator that identifies the resource units included in the physical layer 302 of the cloud. In addition, each layer and/or service deployed within the cloud may stream resource information to the resource manager 310 that specifies any additional resource units implemented by those layers and/or services. The resource manager 310 is then tasked with allocating these resource units to other layers and/or services in the cloud.

In one embodiment, the resource manager 310 is executed on a node within the cloud architecture. More specifically, the resource manger 310 may be loaded on a server and executed by a processor on the server. The resource manager 310 may be coupled to other servers via network resources in the physical layer 302. Resource agents 302 executing on different servers may request resource units from the resource manger 310 by transmitting the request to the resource manager 310 via the network. In such an embodiment, a single instance of the resource manager 310 manages all of the resource units in the cloud.

In one embodiment, the resource manager 310 is a physically distributed, but logically centralized cloud plane. More specifically, a plurality of instances of the resource manager 310 may be loaded onto a plurality of different servers such that any resource agent 312 deployed in the cloud may request resource units from any instance of the resource manger 310 by transmitting the request to one instance of the resource manager 310 via the network. The multiple instances of the resource manager 310 may be configured to communicate such that resource allocation is planned globally be all instances of the resource manager 310. For example, one instance of the resource manager 310 may be loaded onto a single server in each data center 110 to provide high availability of the resource manager 310. In another example, one instance of the resource manager 310 may be loaded onto a single server in each availability zone of a plurality of availability zones. Each availability zone may comprise a number of data centers, such that all data centers in a particular geographic area are served by one instance of the resource manager 310.

The plurality of resource agents 302 may include a variety of resource agent types. Each resource agent 312 includes logic to implement a variety of functions specific to the type of layer or service associated with the resource agent 312. In one embodiment, a resource agent 312 is a stand-alone module designed with specific functionality for a particular layer or service. In another embodiment, a resource agent 312 is a container that wraps an existing resource manager of a service. For example, a service that was written for an existing cloud architecture may be modified to include a resource agent 312 that wraps the resource manager implemented in the service of the existing cloud architecture. The container may utilize the logic of the previous resource manager for certain tasks while making the resource manager compatible with the unified resource manager 310. In yet another embodiment, the resource agent 312 is a lightweight client, referred to herein as a resource agent fleet (RAF), such that only a basic amount of logic is included in the resource agent 312 and more complex logic is assumed to be implemented, if needed, by the resource manager 310. RAF resource agents 302 may be deployed in some SaaS services. A RAF resource agent 312 may be a simple software module that can be used for a variety of services and only provides the minimum level of functionality to make the service compatible with the unified resource manager 310.

The resource manager 310 collects information related to the resource units deployed in the cloud and develops a resource allocation plan allocating the resource units to the layers and/or services deployed in the cloud. A resource allocation plan can be optimized by customizing the allocation of resource units based on different services and applications. However, as the number of services grows, the ability for simple logic implemented within the resource manager 310 to efficiently allocate resource units to the various services becomes more difficult. In such cases, logic to assist in determining how many resource units should be allocated to a particular service based on a specific request for resource units may be implemented external to the resource manager 310 and utilized by the resource manager 310 when developing or adjusting the resource allocation plan.

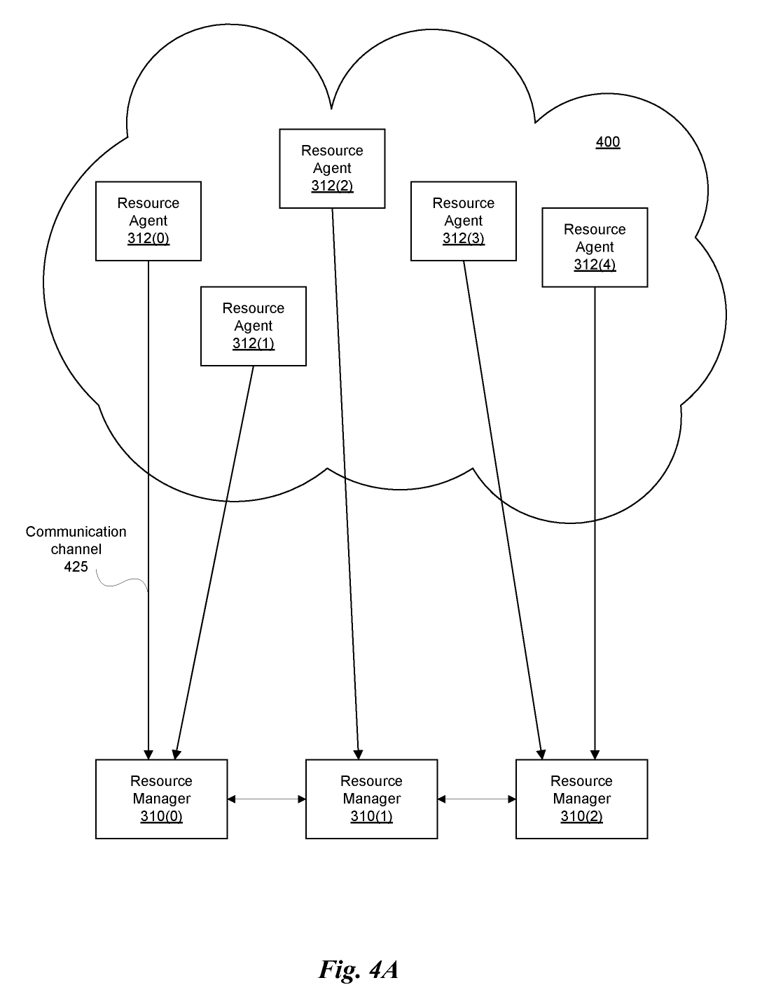

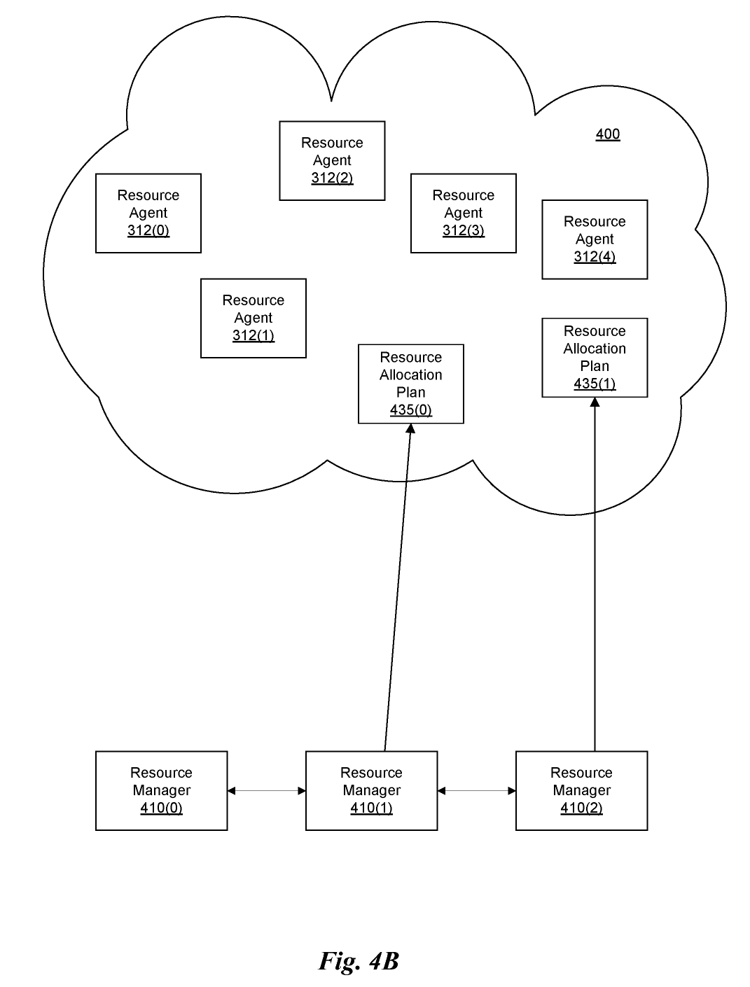

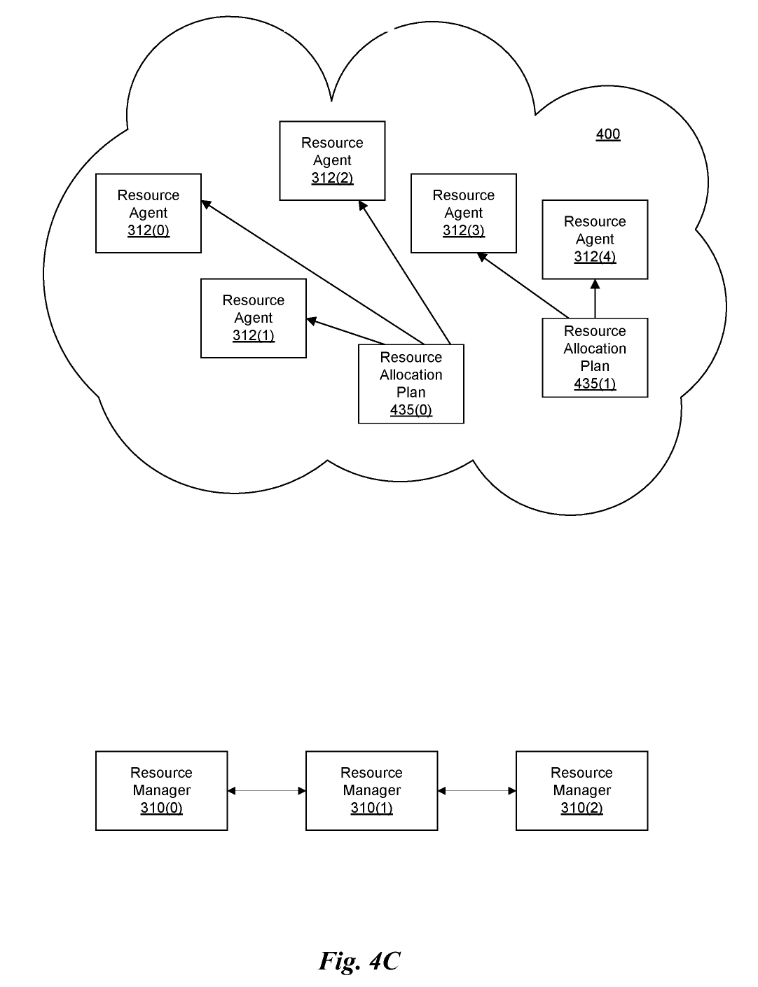

FIGS. 4A through 4C illustrate a technique for allocating resources in the cloud 400 by the resource manager 310, in accordance with one embodiment. Again, the resource manager 310 may be deployed as a physically distributed, but logically centralized cloud plane including a number of instances of the resource manager 310 deployed in different data centers or availability zones of the cloud 400. As shown in FIG. 4A, such a deployment may include a first instance of the resource manager 310(0), a second instance of the resource manager 310(1), and a third instance of the resource manager 310(2) executed on three different nodes in the cloud. Of course, in different embodiments, the number of instances of the resource manager 310 deployed in the cloud may be more than or less than three, including a single instance of the resource manager only located on a single node in the cloud.

The cloud 400 includes a plurality of nodes in one or more data centers, each node in the plurality of nodes in communication with at least one other node in the plurality of nodes through one or more networks. The cloud 400 may also include a plurality of storage devices, each storage device in the plurality of storage devices coupled to a node in the plurality of nodes. The cloud 400 may include a number of layers and/or services deployed therein, each layer and/or service including an instance of a resource agent 312. Each resource agent 312 is configured to manage the execution of tasks using the number of resource units allocated to the resource agent. However, in order to execute tasks, the resource agents 312 are dependent on the resource manager 310 to allocate resource units to the resource agents 312 for executing those tasks. Each resource agent 312 opens a communication channel 425 between the resource agent 312 and one instance of the resource manager 310. As shown in FIG. 4A, a first resource agent 312(0) and a second resource agent 312(1) open a communication channel 425 with the first instance of the resource manager 310(0); a third resource agent 312(2) opens a communication channel 425 with the second instance of the resource manager 310(1); and a fourth resource agent 312(3) and a fifth resource agent 312(4) open a communication channel 425 with a third instance of the resource manager 310(2). The particular instance of the resource manager 310 that a particular resource agent 312 opens a channel of communication between may depend on a location of the resource agent 312 and the locations of the plurality of instances of the resource manager 310. For example, a resource agent 312 may ping each instance of the resource manager 310, where the location in the network of each instance of the resource manager 310 is stored in a configuration file, and measure the response time associated with each instance of the resource manager 310. The resource agent 312 may then open a communication channel 425 with the instance of the resource manager 310 corresponding to the fastest response time.

Once the communication channels 425 are opened, each resource agent 312 is configured to stream data to a corresponding instance of the resource manager 310. In one embodiment, each resource agent 312 streams profile data to the resource manager 310. The profile data includes a resource type identifier, resource utilization information, and a task execution plan. The resource type identifier may identify a type of the resource units managed by the resource agent 312. In other words, the resource type identifier may indicate to the resource manager 310 that resource units of the type specified in the resource type identifier are managed by the resource agent 312 and may be allocated to other resource agents 312 by the resource manager 310. The resource utilization information indicates a number of available resource units managed by the resource agent 312. The resource utilization information may also indicate how many resource units are unavailable (i.e., allocated and not released). For example, the resource agent 312 for a cluster service may indicate how many clusters are managed by the resource agent 312 and a number of clusters that are available to be allocated to a task. The task execution plan indicates a number of tasks managed by the resource agent 312. The task execution play may also indicate an order or priority of the tasks managed by the resource agent 312, information related to a manner for executing the tasks, and/or information related to a number or type of resource units needed to execute the tasks.

Each instance of the resource manager 310 stores the streamed data received from the plurality of resource agents 312 in a memory accessible to each of the other instances of the resource manager 310. In one embodiment, a distributed database is created for storing the streamed profile data. The distributed database may be stored on a plurality of storage devices within the cloud to ensure high availability of the streamed profile data to the instance of the resource manager 310.

The resource manager 310 is tasked with generating a resource allocation plan. The resource allocation plan refers to the allocation of resource units to the plurality of resource agents 312. In one embodiment, the resource allocation plan maps available resource units allocated to each particular resource agent 312 in the plurality of resource agents. Each resource agent 312 in the plurality of resource agents is configured to manage the execution of tasks using the number of resource units allocated to the resource agent 312 in the resource allocation plan. For example, a resource agent 312 for a service in the SaaS layer may be allocated a cluster resource unit in the PaaS layer in the resource allocation plan. Consequently, the resource agent 312 for the service in the SaaS layer may then manage the execution of a task using the allocated cluster resource unit. In one embodiment, the resource manager 310 is configured to allocate resource units to each resource agent 312 in a first-come, first-served basis as resource units are available. However, when the number of available resource units falls below a threshold value, the resource manager 310 adjusts the allocation of resource units based on an algorithm. In one embodiment, the resource manager 310 utilizes a machine-learning algorithm to assist with allocation of resource units. In another embodiment, the resource manager 310 utilizes a priority value assigned to each resource agent 312 or individual tasks managed by each resource agent 312 in order to assist with the allocation of resource units. It will be appreciated that a large number of different algorithms can be implemented by the resource manager 310 in order to allocate resource units among the plurality of resource agents 312. When a task is complete, the resource agent 312 managing the execution of the task may notify the resource manager 310, and the resource manager 310 may update the resource allocation plan to deallocate resource units from the resource agent 312.

In one embodiment, one instance of the resource manager 310 is configured as a master instance of the resource manager 310. The master instance of the resource manager 310 implements the algorithm for generating the resource allocation plan. The other instances of the resource manager 310 are slave instances of the resource manager 310, which simply collect the streamed data from the plurality of resource agents 312 and store the streamed data in the distributed database to be accessed by the master instance of the resource manager 310. Consequently, the logic for allocating resource units to the plurality of resource agents 312 is centralized and controlled by the single instance of the resource manager 310.

In another embodiment, all instances of the resource manager 310 share the task of implementing the algorithm for generating the resource allocation plan. For example, the plurality of resource agents 312 and set of available resource units may be mapped to the plurality of instances of the resource manager 310, and then each instance of the resource manager 310 implements the algorithm for allocating a subset of available resource units among a subset of the plurality of resource agents 312. Thus, each instance of the resource manager 310 generates a portion of the resource allocation plan, and the portions of the resource allocation plan are then combined to form the complete resource allocation plan.

The resource manager 310 may then store the resource allocation plan 435 in the cloud 400. At least one instance of the resource manager 310 is configured to store a copy of the resource allocation plan 435 in the cloud. For example, as shown in FIG. 4B, the second instance of the resource manager 310(1) stores a first instance of the resource allocation plan 435(0) in the cloud, and a third instance of the resource manager 310(2) stores a second instance of the resource allocation plan 435(1) in the cloud.

In one embodiment, multiple instances of the resource allocation plan 435 are stored in the cloud 400, such as by storing instances of the resource allocation plan 435 in multiple data centers to ensure high availability of the resource allocation plan 435 to be accessed by the plurality of resource agents 302. In another embodiment, the resource allocation plan is stored in a distributed file system, such as the Hadoop Distributed File System, as deployed as a service in the cloud 400. The distributed file system may be configured to store multiple redundant copies of the resource allocation plan 435 on a plurality of storage devices.

Each resource agent 312 is then directed to a location of one instance of the resource allocation plan 435 stored in the cloud. As shown in FIG. 4C, the first resource agent 312(0), the second resource agent 312(1), and the third resource agent 312(2) are directed to the location of the first instance of the resource allocation plan 435(0), and the fourth resource agent 312(3) and the fifth resource agent 312(4) are directed to the location of the second instance of the resource allocation plan 435(1). The resource manager 310 may send the location to each resource agent via the communication channel 425. Each resource agent 312 may then read the corresponding instance of the resource allocation plan 435 to determine which resource units have been allocated to that resource agent 312 by the resource manager 310.

It will be appreciated that transmitting the location of the resource allocation plan to each resource agent 312 may be simpler to implement within the resource manager 310 than transmitting specific resource unit allocation information to each resource agent 312 individually. The number of instances of the resource allocation plan 435 to store in the cloud 400 may be increased or decreased dynamically based on the number of resource agents 302 deployed in the cloud. The larger the number of resource agents 302, the more instances of the resource allocation plan 435 that may need to be stored in the cloud 400 to ensure that large numbers of resource agents 302 are able to access the data when needed.

In one embodiment, the resource agents 302 are configured to continuously stream data to the instances of the resource manager 310 to update the profile information. For example, as new tasks are initiated within a service, the corresponding resource agent 312 may notify a corresponding instance of a resource manager 310 of a change in the profile data for the resource agent 312. The new task may require additional resource units to be allocated to the resource agent 312. Similarly, when tasks are completed, the resource agent 312 may stream new profile data to the corresponding instance of the resource manager 310 that enables the resource manager 310 to release some resource units previously allocated to the resource agent 312. The resource manager 310 may adjust the allocation of resource units by modifying the resource allocation plan 435 in the cloud. Resource agents 302 may be configured to poll the resource allocation plan 435 periodically to check for new resource units allocated to the resource agent 312 or to release resource units no longer needed by the resource agent 312.

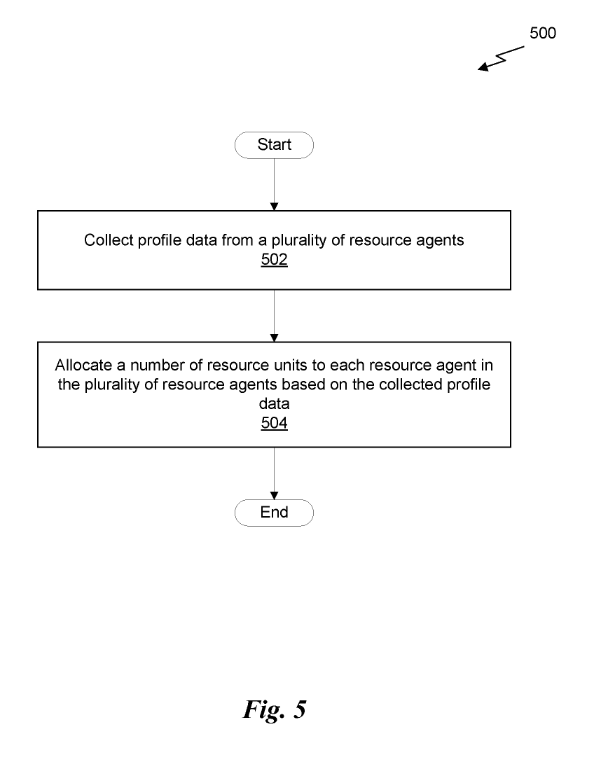

FIG. 5 is a flowchart of a method 500 for managing the allocation of resources in a cloud, in accordance with one embodiment. The method 500 may be performed by hardware, software, or a combination of hardware and software. In one embodiment, the method 500 is implemented by the resource manager 310 executed on one or more nodes of the cloud.

At step 502, profile data is collected from a plurality of resource agents 302. In one embodiment, the plurality of resource agents 302 are deployed in a cloud, with each resource agent 312 in the plurality of resource agents 302 associated with a layer or service in the cloud. Each resource agent 312 streams profile data corresponding to that resource agent 312 to an instance of a resource manager 310. The profile data may include, but is not limited to, a resource type identifier, resource utilization information, and/or a task execution plan.

At step 504, a number of resource units are allocated to each resource agent 312 in the plurality of resource agents 302 based on the collected profile data. In one embodiment, a resource manager 310 is configured to generate a resource allocation plan 435 utilizing the collected profile data. For example, a number of tasks managed by each resource agent 312 may be utilized to calculate a number of resource units to allocate to the resource agent 312. Complicated algorithms, including machine-learning algorithms, may be implemented by the resource manager 310 to generate the resource allocation plan 435 utilizing the collected profile data from all of the resource agents 312 deployed in the cloud. Each resource agent 312 may be configured to read the resource allocation plan 435 to determine which resource units have been allocated to the resource agent 312 by the resource manager 310.

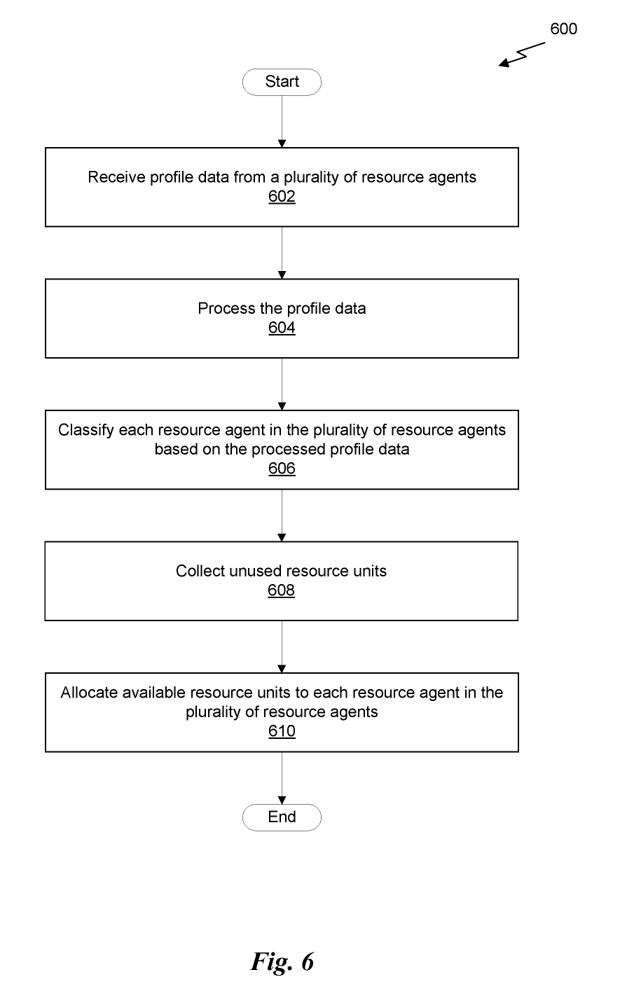

FIG. 6 is a flowchart of a method 600 for managing the allocation of resources in a cloud, in accordance with one embodiment. The method 600 may be performed by hardware, software, or a combination of hardware and software. In one embodiment, the method 600 is implemented by the resource manager 310 executed on one or more nodes of the cloud.

At step 602, profile data is received from a plurality of resource agents 312. In one embodiment, the profile data is received by one of a plurality of instances of a resource manager 310 and stored in a distributed database accessible to each instance of the resource manager 310. At step 604, the profile data is processed. In one embodiment, at least one instance of the resource manager 310 processes the profile data collected from the plurality of resource agents 302. For example, the resource manager 310 may calculate a total number of resource units available within the cloud, or the resource manager 310 may calculate a total number of tasks managed by each resource agent 312 by counting the number of tasks enumerated in the profile data from each resource agent 312.

At step 606, each resource agent 312 in the plurality of resource agents 312 is classified based on the processed profile data. In one embodiment, the classification can indicate a priority of the resource agent 312 for allocation purposes. At step 608, unused resource units are collected. In one embodiment, the resource manager 310 is configured to compare the number of resource units currently allocated to a resource agent 312 with the number of tasks managed by the resource agent 312. If the number of resource units allocated to the resource agent 312 exceeds the number of resource units necessary to execute the number of tasks managed by the resource agent 312, then the resource manager 310 may release at least some of the resource units allocated to the resource agent 312 to allow those resource units to be allocated to different resource agents 312. The resource manager 310 may track how many resource units are currently allocated to various resource agents 312 and how many resource units are available to be allocated to resource agents 312.

At step 610, available resource units are allocated to each resource agent 312 in the plurality of resource agents 312. In one embodiment, the resource manager 310 updates the resource allocation plan 435 to indicate a number of resource units allocated to each resource agent 312. The resource manager 310 may be configured with a number of algorithms for determining how to allocate resources among the plurality of resource agents 312. Types of algorithms include, but are not limited to, first-come, first-served algorithms, priority-based algorithms, and machine-learning algorithms based on resource utilization statistics.

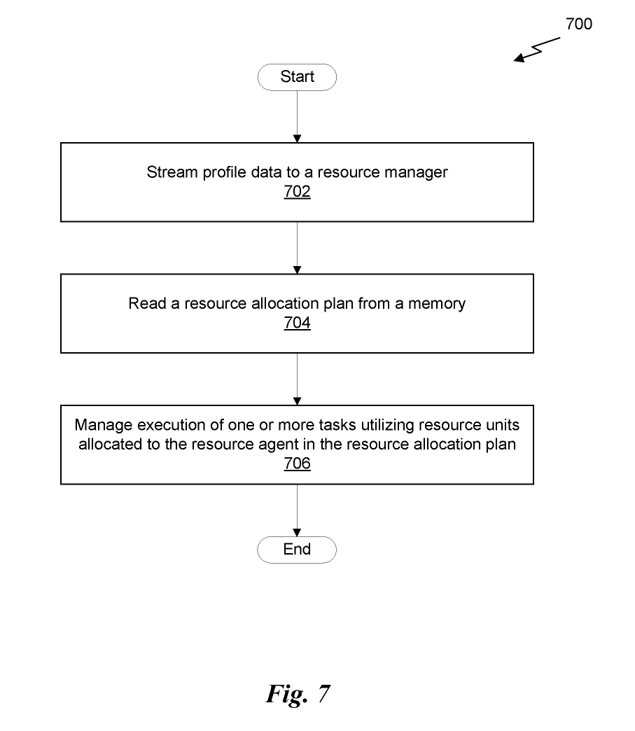

FIG. 7 is a flowchart of a method 700 for managing the execution of tasks by a service, in accordance with one embodiment. The method 700 may be performed by hardware, software, or a combination of hardware and software. In one embodiment, the method 700 is implemented by a resource agent 312 executed on one or more nodes of the cloud.

At step 702, profile data is streamed to a resource manager 310. In one embodiment, a resource agent 312 is configured to generate a data structure in a memory to store profile data. The profile data may include information related to resource units made available by a layer or service associated with the resource agent 312, a number of tasks currently managed by the resource agent 312, and the like. The profile data may also include a request for resource units to be allocated to the resource agent 312. The data structure may then be streamed to an instance of the resource manager 310 via a communication channel 425.

At step 704, a resource allocation plan 435 is read from a memory. In one embodiment, the resource agent 312 receives a location of the resource allocation plan 435 from the resource manager 310, and reads allocation information that indicates a number of resource units allocated to the resource agent 312 from the resource allocation plan 435 in the memory.

At step 706, execution of one or more tasks is managed utilizing resource units allocated to the resource agent 312 in the resource allocation plan 435. In one embodiment, the resource agent 312 may utilize resource units allocated to the resource agent 312 for executing tasks managed by the resource agent 312. For example, a CSU 154 allocated to the resource agent 312 may be utilized to process data for the task or execute a set of instructions to perform a particular function. In another example, a cluster allocated to the resource agent 312 may be utilized to execute a task using the tools implemented by the cluster.

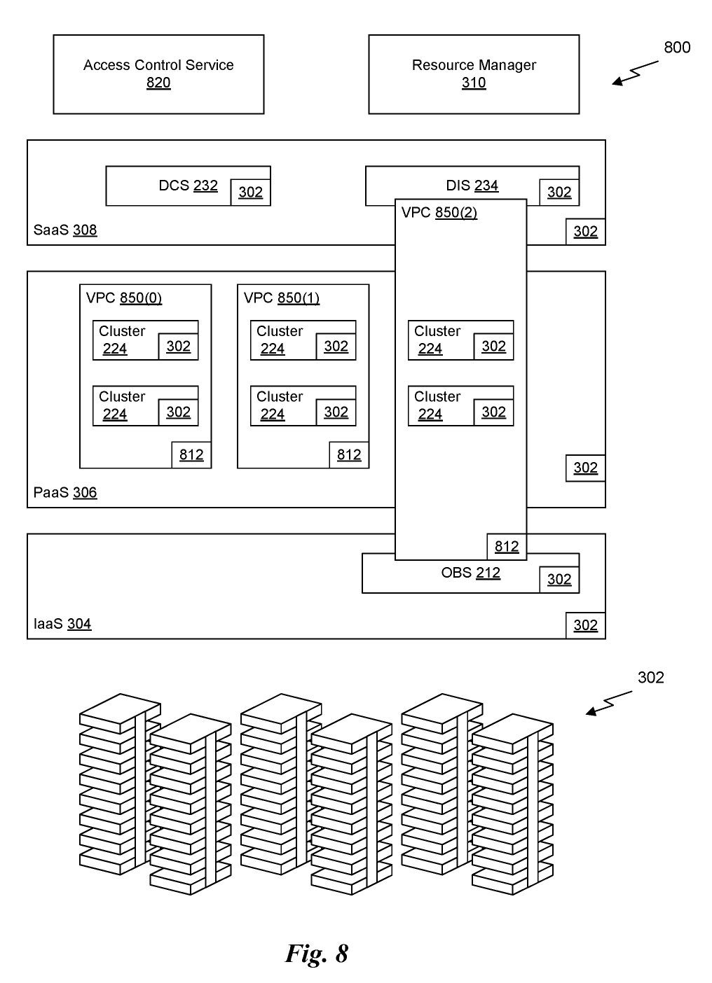

FIG. 8 is a conceptual illustration of a cloud architecture 800, in accordance with one embodiment. As shown in FIG. 8, the cloud architecture 800 is represented as a plurality of hierarchical layers, similar to the cloud architecture 200 shown in FIG. 2 and the cloud architecture 300 shown in FIG. 3. The cloud architecture 800 may include a number of services in the different hierarchical layers (e.g., layers 304, 306, 308), such as the DCS service 232 and the DIS service 234 in the SaaS layer 206. Each hierarchical layer and service may each include a resource agent 312 that is in communication with a resource manager 310.

The cloud architecture 800 also includes provisions for virtual private clouds (VPCs) 850. A VPC 850 is a set of resources/services allocated to a particular client, such as a business customer. A number of users for the client may be granted access to the VPC 850 to perform tasks using the resources/services included in the VPC 850. As shown in FIG. 8, a VPC 850 may include resources/services in a particular layer of the cloud (e.g., VPC 850(0) and VPC 850(1)) or the VPC 850 may include resources/services across multiple layers of the cloud (e.g., VPC 850(2)). It will be appreciated that the resources and/or services allocated within a VPC 850 may be assigned to a particular client and, therefore, access to the VPC 850 should be restricted to user's authorized by the client.

In one embodiment, each VPC 850 may include a secure resource agent (SRA) 812, which is similar to a resource agent 312, described above, but also includes an additional functionality of authentication and encryption. When a VPC 850 is provisioned, the SRA 812 establishes an encrypted channel of communication between the resource manager 310 and the SRA 812. The SRA 812 is configured to stream profile data to the resource manager 310 in order for the resource manager 310 to allocate resources to the VPC 850. The SRA 812 also establishes a channel of communication with any resource manager 312 implemented within a service included in the VPC 850. The resource agents 312 implemented within a service of the VPC 850 are configured to stream profile data to the SRA 812, which aggregates the profile data for the services in the VPC 850 and streams the profile data to the resource manger 310 via the encrypted channel of communications.

When any user creates a task for any service within the VPC 850, the SRA 812 is configured to manage the task. Task management includes authentication of the user that created the task as being authorized by a particular client to access the VPC 850. The authentication is performed by transmitting a request from the SRA 812 to an access control service 820. The access control service 820 is configured to check credentials provided by the user in order to authenticate the user. In one embodiment, the credentials may include a username/password combination that is checked against a database of username/password pairs authorized by the client. If the password provided with the username matches the password store in the database of username/pas sword pairs authorized by the client, then the access control service 820 may authorize the user. An authorized user may be referred to herein as a tenant of the VPC 850. The access control service 820 transmits a response to the SRA 812 that indicates whether the user for a particular task is an authorized tenant. If the user is an authorized tenant of the VPC 850, then the SRA 812 manages the execution of the task by a particular service in the VPC 850. However, if the user is not an authorized tenant of the VPC 850, then the SRA 812 prevents execution of the task by the services in the VPC 850, thereby restricting access to the VPC 850 to only authorized tenants.

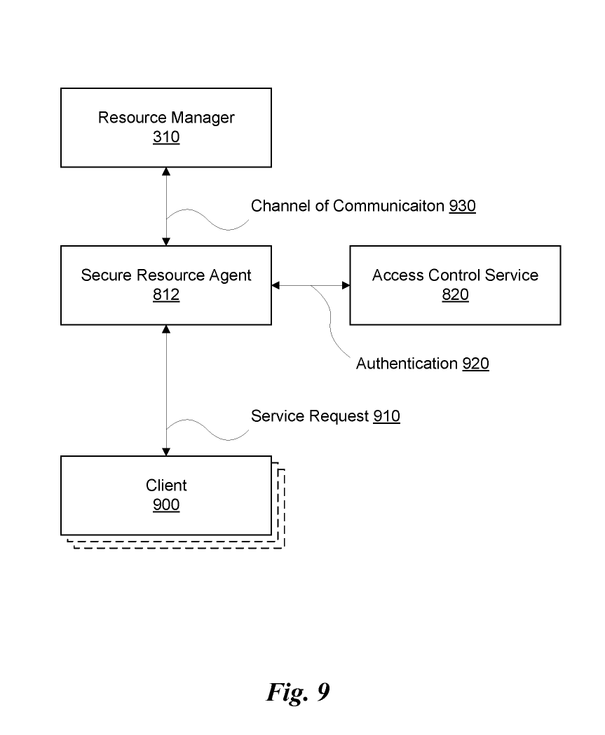

FIG. 9 illustrates the communications between a secure resource agent 812, in accordance with one embodiment. As shown in FIG. 9, the SRA 812 establishes an encrypted channel of communications 930 with the resource manager 310 in order to request resources to be allocated to the VPC 850. The SRA 812 also receives service requests 910 from one or more clients 900. The service requests 910 may be a request to create a task to be executed by a service. The service requests 910 may also include the credentials for a user creating the service request 910. The SRA 812 transmits an authentication request to the access control service 820 that includes the credentials for the user. If the access control service 820 authenticates the user as an authorized tenant, then the SRA 812 generates a task in response to the service request 910 and manages the execution of the task using the resources allocated to the service by the resource manager 310. However, if the access control service 820 does not authenticate the user, the SRA 812 may deny the service request 910 and transmit a response to the service request 910 to the client that indicates that the user is not authorized to use the services of the VPC 850.

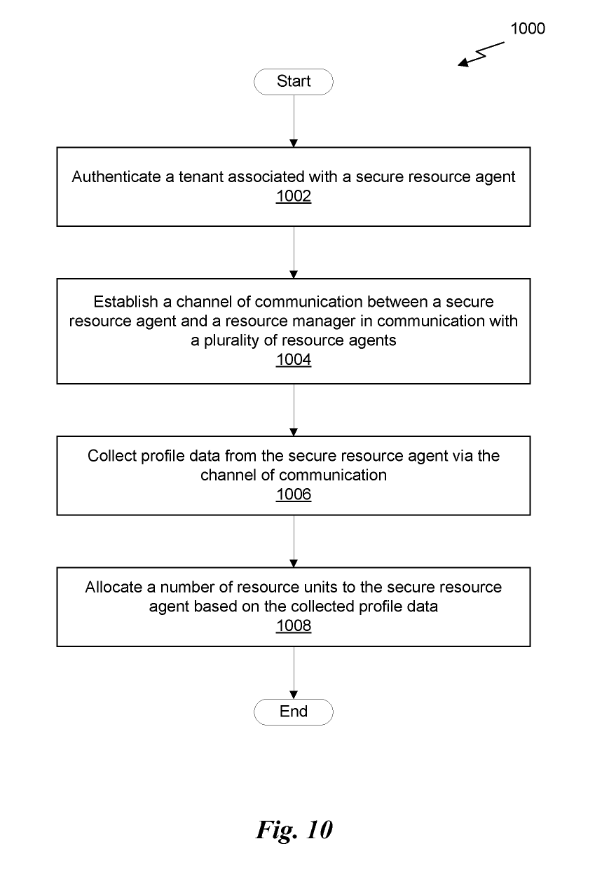

FIG. 10 is a flowchart of a method 1000 for managing the allocation of resources in a cloud, in accordance with one embodiment. The method 1000 may be performed by hardware, software, or a combination of hardware and software. In one embodiment, the method 1000 is implemented by a combination of a secure resource agent 812, the access control service 820, and the resource manager 310 executed on one or more nodes of the cloud.

At step 1002, the access control service 820 authenticates a tenant associated with a secure resource agent 812. In one embodiment, a user initiates a request to utilize a service in a VPC 850 to perform a task. The request includes credentials for the user and is received at the SRA 812 for the VPC 850. The SRA 812 transmits a request to authenticate the user to the access control service 820, where the request includes the credentials of the user. The access control service may check the credentials provided by the user against a database of credentials of authorized tenants granted access to the VPC 850. The access control service 820 transmits a message to the SRA 812 to authenticate the user as an authorized tenant if the credentials provided by the user match the credentials in the database.

At step 1004, a channel of communication is established between the SRA 812 and a resource manager 310 in communication with a plurality of resource agents. At step 1006, the resource manager 310 collects profile data from the SRA 812 via the channel of communication. In one embodiment, the SRA 812 may aggregate profile data from a plurality of resource agents implemented in services included within the VPC 850 and stream to aggregate profile data to the resource manger 310 in order to request resources be allocated to the various services in the VPC 850. At step 1008, the resource manger 310 allocates a number of resource units to the SRA 812 based on the collected profile data. The SRA 812 manages tasks executed by the services utilizing the number of resource units.

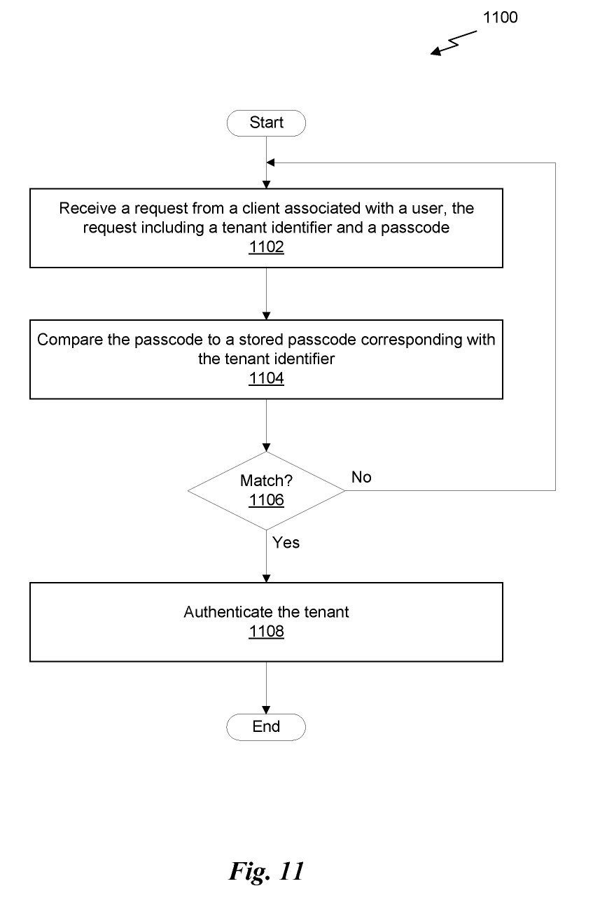

FIG. 11 is a flowchart of a method 1100 for authenticating an authorized tenant associated with a virtual private cloud, in accordance with one embodiment. The method 1100 may be performed by hardware, software, or a combination of hardware and software. In one embodiment, the method 1100 is implemented by a combination of a secure resource agent 812, the access control service 820, and the resource manager 310 executed on one or more nodes of the cloud.

At step 1102, a request is received from a client associated with a user. In one embodiment, the request includes credentials including a tenant identifier and a passcode. The request may be a service request transmitted from the client 900 to the SRA 812. At step 1104, the passcode is compared to a stored passcode corresponding with the tenant identifier. In one embodiment, the SRA 812 forwards an authentication request to the access control service 820 that includes the tenant identifier and passcode. The access control service 820 uses the tenant identifier to look up a stored passcode corresponding with the tenant identifier in a database. The access control service 820 compares the passcode received in the authentication request with the stored passcode to authenticate the user. At step 1106, the access control service 820 determines whether the passcode matches the stored passcode. If there is not a match, then the access control service 820 forwards a response to the SRA 812 that indicates the user is not an authorized tenant and the method 1100 returns to step 1102 where other requests may be processed to authenticate one or more other users. However, if there is a match at step 1106, then, at step 1108, the access control service 820 authenticates the user as an authorized tenant. The access control service 820 may transmit a message to the SRA 812 that identifies the user as an authorized tenant and the SRA 812 may grant access to the user to execute tasks via the one or more services in the VPC 850.

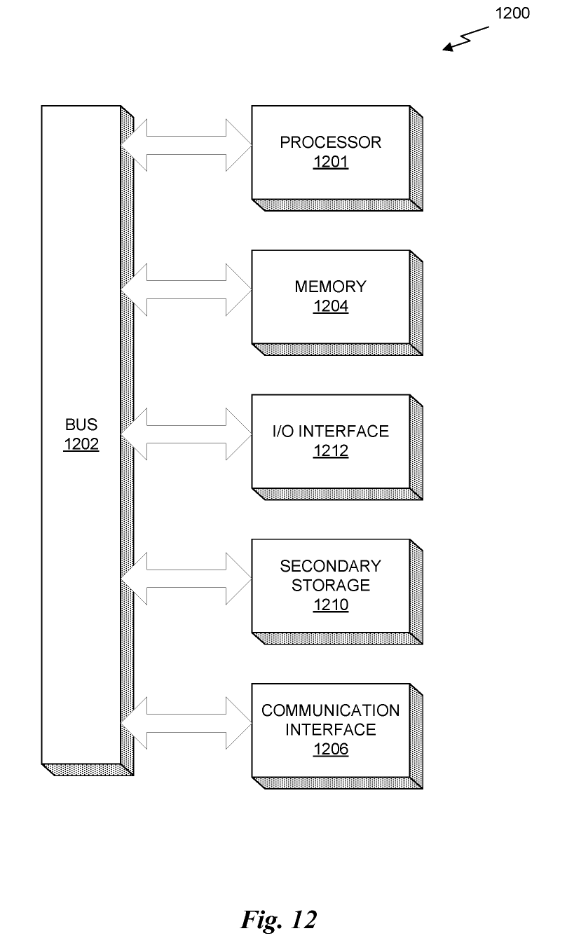

FIG. 12 illustrates an exemplary system 1200 in which the various architecture and/or functionality of the various previous embodiments may be implemented. As shown, a system 1200 is provided including at least one processor 1201 that is connected to a communication bus 1202. The communication bus 1202 may be implemented using any suitable protocol, such as PCI (Peripheral Component Interconnect), PCI-Express, AGP (Accelerated Graphics Port), HyperTransport, or any other bus or point-to-point communication protocol(s). The system 1200 also includes a memory 1204. Control logic (software) and data are stored in the memory 1204 which may take the form of random access memory (RAM).

The system 1200 also includes an input/output (I/O) interface 1212 and a communication interface 1206. User input may be received from the input devices 1212, e.g., keyboard, mouse, touchpad, microphone, and the like. In one embodiment, the communication interface 1206 may be coupled to a graphics processor (not shown) that includes a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 1200 may also include a secondary storage 1210. The secondary storage 1210 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the memory 1204 and/or the secondary storage 1210. Such computer programs, when executed, enable the system 1200 to perform various functions. The memory 1204, the storage 1210, and/or any other storage are possible examples of computer-readable media.

In one embodiment, the architecture and/or functionality of the various previous figures may be implemented in the context of the processor 1201, a graphics processor coupled to communication interface 1206, an integrated circuit (not shown) that is capable of at least a portion of the capabilities of both the processor 1201 and a graphics processor, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 1200 may take the form of a desktop computer, laptop computer, server, workstation, game consoles, embedded system, and/or any other type of logic. Still yet, the system 1200 may take the form of various other devices including, but not limited to a personal digital assistant (PDA) device, a mobile phone device, a television, etc.

Further, while not shown, the system 1200 may be coupled to a network (e.g., a telecommunications network, local area network (LAN), wireless network, wide area network (WAN) such as the Internet, peer-to-peer network, cable network, or the like) for communication purposes.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the embodiments as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer-implemented method for allocating resources within a cloud, comprising:
collecting profile data from a plurality of resource agents; and
allocating, via a resource manager in communication with the plurality of resource agents, a number of resource units to each resource agent in the plurality of resource agents based on the collected profile data.

2. The method of claim 1, wherein each resource agent in the plurality of resource agents is configured to manage the execution of tasks using the number of resource units allocated to the resource agent.

3. The method of claim 1, wherein the cloud comprises a plurality of nodes in one or more data centers, each node in the plurality of nodes in communication with at least one other node in the plurality of nodes through one or more networks.

4. The method of claim 3, wherein the cloud further comprises a plurality of storage devices, each storage device in the plurality of storage devices coupled to a node in the plurality of nodes.

5. The method of claim 3, wherein the resource manager includes at least two instances of the resource manager distributed across at least two nodes in the cloud.

6. The method of claim 1, wherein at least one resource agent in the plurality of resource agents is a resource agent fleet.

7. The method of claim 1, wherein the profile data for a particular resource agent includes a resource type identifier, resource utilization information, and a task execution plan.

8. The method of claim 1, wherein the resource manager is configured to generate a resource allocation plan that is stored in a distributed file system in the cloud, and wherein each resource agent in the plurality of resource agents is configured to access at least one instance of the resource allocation plan in the distributed file system.

9. The method of claim 1, further comprising:
establishing a secure channel of communication between a secure resource agent and the resource manager
authenticating, via an access control service, a user associated with the secure resource agent as an authorized tenant;
collecting profile data from the secure resource agent via the encrypted channel of communication; and
allocating, via the resource manager, a number of resource units to the secure resource agent based on the collected profile data.

10. The method of claim 9, wherein the secure resource agent is configured to manage the execution of tasks within a virtual private cloud.

11. A system for allocating resources within a cloud, comprising:
a non-transitory memory storage comprising instructions; and
one or more processors in communication with the memory, wherein the one or more processors execute the instructions to:
collect profile data from a plurality of resource agents, and
allocate, via a resource manager in communication with the plurality of resource agents, a number of resource units to each resource agent in the plurality of resource agents based on the collected profile data.

12. The system of claim 11, wherein each resource agent in the plurality of resource agents is configured to manage the execution of tasks using the number of resource units allocated to the resource agent.

13. The system of claim 11, wherein the cloud comprises a plurality of nodes in one or more data centers, each node in the plurality of nodes in communication with at least one other node in the plurality of nodes through one or more networks.

14. The system of claim 13, wherein the cloud further comprises a plurality of storage devices, each storage device in the plurality of storage devices coupled to a node in the plurality of nodes.

15. The system of claim 13, wherein the resource manager includes at least two instances of the resource manager distributed across at least two nodes in the cloud.

16. The system of claim 11, wherein at least one resource agent in the plurality of resource agents is a resource agent fleet.

17. The system of claim 11, wherein the profile data for a particular resource agent includes a resource type identifier, resource utilization information, and a task execution plan.

18. The system of claim 11, wherein the resource manager is configured to generate a resource allocation plan that is stored in a distributed file system in the cloud, and wherein each resource agent in the plurality of resource agents is configured to access at least one instance of the resource allocation plan in the distributed file system.

19. The system of claim 11, wherein the one or more processors execute the instructions to:
establish a secure channel of communication between a secure resource agent and the resource manager;
authenticate, via an access control service, a user associated with the secure resource agent as an authorized tenant;
collect profile data from the secure resource agent via the encrypted channel of communication; and
allocate, via the resource manager, a number of resource units to the secure resource agent based on the collected profile data.

20. The system of claim 19, wherein the secure resource agent is configured to manage the execution of tasks within a virtual private cloud.

21. A non-transitory computer-readable media storing computer instructions for allocating resources within a cloud that, when executed by one or more processors, cause the one or more processors to perform the steps of:
collecting profile data from a plurality of resource agents executed on one or more nodes in the cloud;
allocating, via a resource manager in communication with the plurality of resource agents, a number of resource units to each resource agent in the plurality of resource agents based on the collected profile data.

22. The non-transitory computer-readable media of claim 21, wherein each resource agent in the plurality of resource agents is configured to manage the execution of tasks using the number of resource units allocated to the resource agent.

23. The non-transitory computer-readable media of claim 21, wherein the cloud comprises a plurality of nodes in one or more data centers, each node in the plurality of nodes in communication with at least one other node in the plurality of nodes through one or more networks.

24. The non-transitory computer-readable media of claim 21, wherein the resource manager is configured to generate a resource allocation plan that is stored in a distributed file system in the cloud, and wherein each resource agent in the plurality of resource agents is configured to access at least one instance of the resource allocation plan in the distributed file system.

25. The non-transitory computer-readable media of claim 21, the steps further comprising:
establishing a secure channel of communication between a secure resource agent and the resource manager
authenticating, via an access control service, a user associated with the secure resource agent as an authorized tenant;
collecting profile data from the secure resource agent via the encrypted channel of communication; and
allocating, via the resource manager, a number of resource units to the secure resource agent based on the collected profile data.
